(19) United States
(12) Patent Application Publication
(10) Pub. No.: US 2012/0143962 A1
(43) Pub. Date: Jun. 7, 2012

(54) Intelligent Email Management System

(75) Inventors: Judith H. Bank, Morrisville, NC (US); Lisa M. Wood Bradley, Cary, NC (US); Lin Sun, Morrisville, NC (US); ChunHui Yang, Durham, NC (US)

(73) Assignee: INTERNATIONAL BUSINESS MACHINES CORPORATION, Armonk, NY (US)

(21) Appl. No.: 12/961,002

(22) Filed: Dec. 6, 2010

(51) Int. Cl. G06F 15/16

(52) U.S. Cl. 709/206

(57) ABSTRACT

A method, apparatus, and computer program product for processing email messages. A processor unit generates an email processing profile for a user based on a number of registration activities by the user. Responsive to receiving an email message for the user, the processor unit processes the email message using the email processing profile.

### BACKGROUND

1. Field

The present disclosure relates generally to an improved data processing system and, in particular, to a method and apparatus for processing data. Still more particularly, the present disclosure relates to a method and apparatus for identifying unwanted email messages.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travels over the Internet through a variety of languages also referred to as protocols. The set of protocols used on the Internet is called the Transmission Control Protocol/Internet Protocol (TCP/IP).

The Internet has revolutionized communications and commerce along with becoming a source of information and entertainment. For many users, email is a widely used format to communicate over the Internet. It is a common place for users to send email messages to other users through the Internet.

The use of email messages is a common place for home and business use. Email messages are used by individuals to keep in touch with and communicate with other users. Additionally, email messages provide a medium to collaborate and exchange documents.

Unsolicited email messages are often received by users in their inboxes. These types of messages are also referred to as junk email or unsolicited bulk email. The amount of undesired email messages sent to users has grown over time. With the amount of undesired email messages present, users often have to wade through numerous email messages to find the ones that they wish to read.

With issues involving undesired email messages, various email message techniques have been implemented to identify email messages that are undesired. These techniques include checking for key words that have been identified in undesired email messages. Other techniques may include users identifying email messages received in inboxes as being undesired.

### SUMMARY

The different illustrative embodiments provide a method, apparatus, and computer program product for processing email messages. In one embodiment a processor unit generates an email processing profile for a user based on a number of registration activities by the user. Responsive to receiving an email message for the user, the processor unit processes the email message using the email processing profile.

### BRIEF DESCRIPTION OF THE SEVERAL VIEWS OF THE DRAWINGS

FIG. 1 is an illustrative diagram of a data processing environment in which illustrative embodiments may be implemented;

FIG. 2 is an illustration of a data processing system in accordance with an illustrative embodiment;

FIG. 3 is a diagram illustrating an email messaging system in accordance with an illustrative embodiment;

FIG. 4 is an illustration of an email processing profile in accordance with an illustrative embodiment;

FIG. 5 is a flowchart of a process for processing email messages in accordance with an illustrative embodiment; and

FIG. 6 is a flowchart of a process for generating a history of registration activities in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium that can communicate, propagate, or transport a program for use by or in connection with an instruction processing system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language, such as Java, Smalltalk, C++, or the like; and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowcharts and/or block diagrams of methods, apparatus (systems), and computer program products according to embodiments of the invention. It will be understood that each block of the flowcharts and/or block diagrams, and combinations of blocks in the flowcharts and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions, which implement the function/act specified in the flowcharts and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions, which execute on the computer or other programmable apparatus, provide processes for implementing the functions/acts specified in the flowcharts and/or block diagram block or blocks.

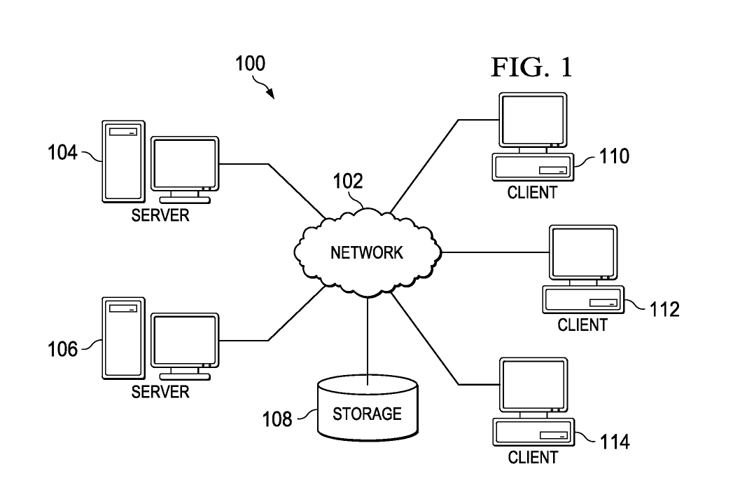

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

In this depicted example, client computers 110, 112, and 114 may send and receive email messages via at least one of server computer 104 and server computer 106. One or more of the different illustrative embodiments may be implemented in network data processing system 100 to manage the delivery of email messages.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example and not as an architectural limitation for the different illustrative embodiments.

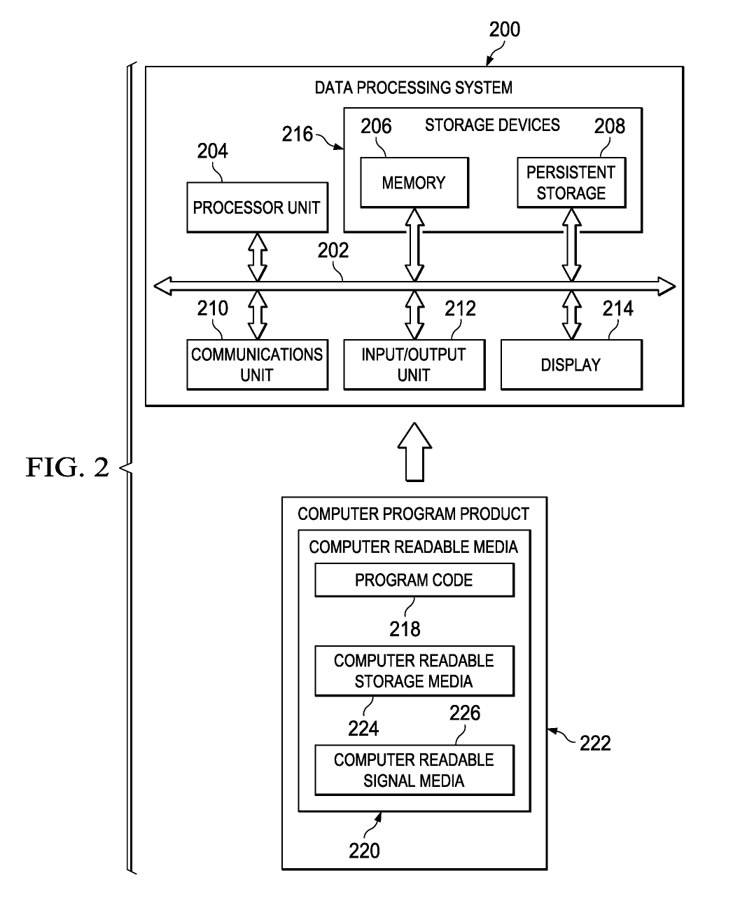

Turning now to FIG. 2, an illustration of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 may be used to implement computers, such as server computer 106 and client computer 110 in FIG. 1. Additionally, data processing system 200 may be used to implement other types of devices, such as notebook computers, desktop computers, mobile phones, and other suitable types of devices.

Processor unit 204 serves to process instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information, either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and/or wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for processing by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto, or transferred to, data processing system 200 for processing by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these examples, computer readable storage media 224 is a physical or tangible storage device used to store program code 218, rather than a medium that propagates or transmits program code 218. Computer readable storage media 224 is also referred to as a computer readable tangible storage device or a computer readable physical storage device. In other words, computer readable storage media 224 is a media that can be touched by a person.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server to data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide physical or architectural limitations to the manner in which different embodiments may be implemented. The different illustrative embodiments may be implemented in a data processing system including components in addition to or in place of those illustrated for data processing system 200. Other components shown in FIG. 2 may be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 204 may take the form of a hardware unit with circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 206, or a cache, such as found in an interface and memory controller hub that may be present in communications fabric 202.

The different illustrative embodiments recognize and take into account a number of different considerations. For example, the different illustrative embodiments recognize and take into account that currently used techniques may provide false positives. In other words, email messages that a user may desire to read may be placed into another folder for undesired email messages instead of the inbox for the user.

The different illustrative embodiments also recognize and take into account that some of the currently used techniques for blocking undesired email messages include blocking email addresses. These types of techniques are useful but require a user to input or select addresses that should be blocked.

Thus, the different illustrative embodiments of the present invention provide a computer-implemented method, apparatus, computer system, and computer program product for processing email messages. In one illustrative embodiment, an email processing profile is generated for a user based on the history of registration activities by the user. In response to receiving an email message for the user, the email message is processed using the email processing profile.

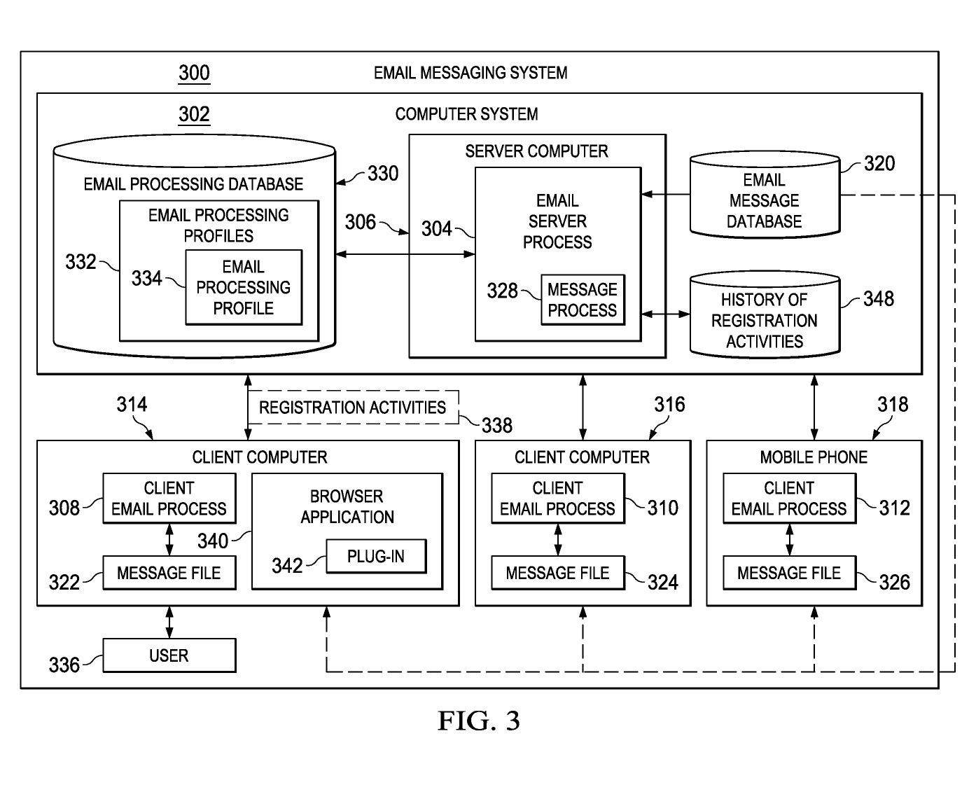

With reference now to FIG. 3, a diagram illustrating an email messaging system is depicted in accordance with an illustrative embodiment. Email messaging system 300 is an example of a messaging system that may be implemented in network data processing system 100 in FIG. 1.

As depicted, email messaging system 300 includes computer system 302. Email server process 304 runs on computer system 302. Server computer 306 may be, for example, server computer 104 in FIG. 1 implemented using data processing system 200 in FIG. 2.

In this illustrative example, email messaging system 300 includes email server process 304, which runs on server computer 306. Email server process 304 facilitates the exchange of messages between client email processes, such as client email process 308, client email process 310, and client email process 312.

In these illustrative examples, client email process 308 runs on client computer 314, client email process 310 runs on client computer 316, and client email process 312 runs on mobile phone 318. Although three client email processes are illustrated, other numbers of client email processes may be present within email messaging system 300.

Further, other devices may be present in addition to and/or in place of client computers and mobile phones. For example, without limitation, a laptop computer, a tablet, a personal computer, and other suitable types of data processing systems may be present within email messaging system 300.

In these illustrative examples, email server process 304 stores email messages for the different client email processes in email message database 320. The client email processes may store messages locally. For example, client email process 308 may store email messages in message file 322, client email process 310 may store email messages in message file 324, and client email process 312 may store email messages in message file 326. These message files store email messages received by the clients and may be organized into various mailboxes. Examples of various mailboxes include an inbox folder, a sent folder, a deleted folder, and an outbox folder.

These client email processes may employ different protocols, depending upon the implementation. For example, simple mail transfer protocol (SMTP) is a standard email protocol that is based on TCP/IP. This protocol defines a message format and the message transfer agent which stores and forwards the mail. Other protocols, such as post office protocol 3 (POP3), also may be employed.

When a client email process connects to email server process 304, any messages stored for that particular client email process in email message database 320 are sent to that client email process. Additionally, the client email process contacting email server process 304 may also send email messages to email server process 304 for distribution to other client email processes.

In some cases, the email messages may be stored on email message database 320 without downloading the email messages. With this type of email system, client email processes may be web-based ones in which email is accessed using a web browser.

In this illustrative example, email server process 304 includes message process 328. Message process 328 processes email messages directed from senders to determine whether the email messages should be delivered to the receiver's inbox. In these illustrative examples, message process 328 accesses email processing database 330.

In these illustrative examples, email processing database 330 contains email processing profiles 332. Email processing profiles 332 are associated with users who may be recipients of email messages. For example, email processing profile 334 may be associated with user 336 at client computer 316.

Email processing profiles 332 include rules for determining whether email messages are to be delivered to the inbox of a user. For example, email processing profile 334 may be an email filtering profile that includes any number of email filters for filtering for desired emails.

In these illustrative examples, user 336 interacts with browser application 340 and performs registration activities 338. Browser application 340 is configured to access information on a network. For example, network browser application 340 may retrieve and present information from resources on the Worldwide Web. Browser application 340 may be used to access information on networks that may not be located on the Worldwide Web. Further, in some illustrative examples, browser application 340 may be used to save information to file systems. Examples of browser applications include Mozilla, Firefox, Internet Explorer, Google Chrome, and other suitable types of applications.

In these examples, registration activities 338 performed by user 336 is detected by plug-in 342 for browser application 340. A plug-in is a set of software components configured to add capabilities or functions to a software application.

Registration activities 338 comprise any activities in which user 336 provides information indicating that user 336 desires to become associated with a particular entity. In these depicted examples, the entity is a website. In the depicted examples, registration activities 338 are ones in which user 336 desires a relationship with the entity. This relationship may be a continuing relationship in which user 336 may receive information from the entity for some period of time. In some cases, the continuing relationship may last until user 336 performs an action to discontinue the relationship. In other cases, the continuing relationship may end after an event. This event may be, for example, the end of a subscription, delivery of goods or services, or some other suitable event.

In the illustrative examples, registration activities 338 indicate that user 336 desires to have a relationship with the entity. Thus, the illustrative examples use registration activities 338 to identify entities from which user 336 desires to receive email messages.

These types of activities are in contrast to those in which user 336 performs that result merely in the addition of universal resource locators to a browser history. Visits to a website and selecting links to see different pages in a website are not registration activities, in these illustrative examples, unless more activities occur that indicate that user 336 desires a relationship with the entity. The activities that form registration activities are ones that user 336 performs to establish a relationship with the entity in the depicted examples.

User 336 may become associated by performing activities to obtain a membership with an entity or obtain a subscription for services or information from the entity. For example, registration activities 338 include any activities in which user 336 provides information to register with an entity to receive information from the entity. This information may be, for example, information about goods and services offered by the entity, information about a purchase made from the entity, or other suitable actions that indicate user 336 desires information from the entity.

Registration activities 338 may take a number of different forms. For example, a registration activity may include user 336 entering an email address into a form at a website. The entry of an email address may be to register for information from a website. The entry of an email address also may be performed to register with the website to receive information about a purchase that user 336 makes. In addition to email addresses, registration activities 338 also may include information identifying the type of interaction desired with the entity. Registration activities 338 also may include, for example, without limitation, topics of interest to user 336. For example, user 336 may indicate an interest in receiving information about women's clothing, but not men's clothing. Further, topics of interest may include certain keywords or key phrases in the body of an email and/or the subject of an email.

Registration activities 338 identified by plug-in 342 are sent to message process 328 in email server process 304 on server computer 306. Registration activities 338 are added to history of registration activities 348 for user 336. Message process 328 uses history of registration activities 348 and may be used to create email processing profile 334. Registration activities 338 also may be used to update email processing profile 334.

History of registration activities 348 is used by message process 328 to generate email processing profile 334, update email processing profile 334, or perform a combination of the two.

In this manner, message process 328 may more accurately identify email messages that a user desires to read. In these illustrative examples, message process 328 using email processing profiles 332 essentially provides a white list for desired email messages. In other words, information in email processing profiles 332 is used to identify contacts or sources from which users desire to receive email messages. If an email message is not identified as a desired message that the user wants to receive, other processes used to identify undesired email messages may then be employed to determine whether to deliver the email message to the user's inbox. These processes may be included in message process 328 or other processes for email server process 304.

The illustration of email messaging system 300 in FIG. 3 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative embodiments, message process 328 may be located at a client data processing system instead of on a server data processing system. In one illustrative example, message process 328 may be implemented in client email process 310. Email processing profile 334 for user 336 may still be located on server computer 306. In yet other illustrative examples, email processing profile 334 may be located locally at client computer 314.

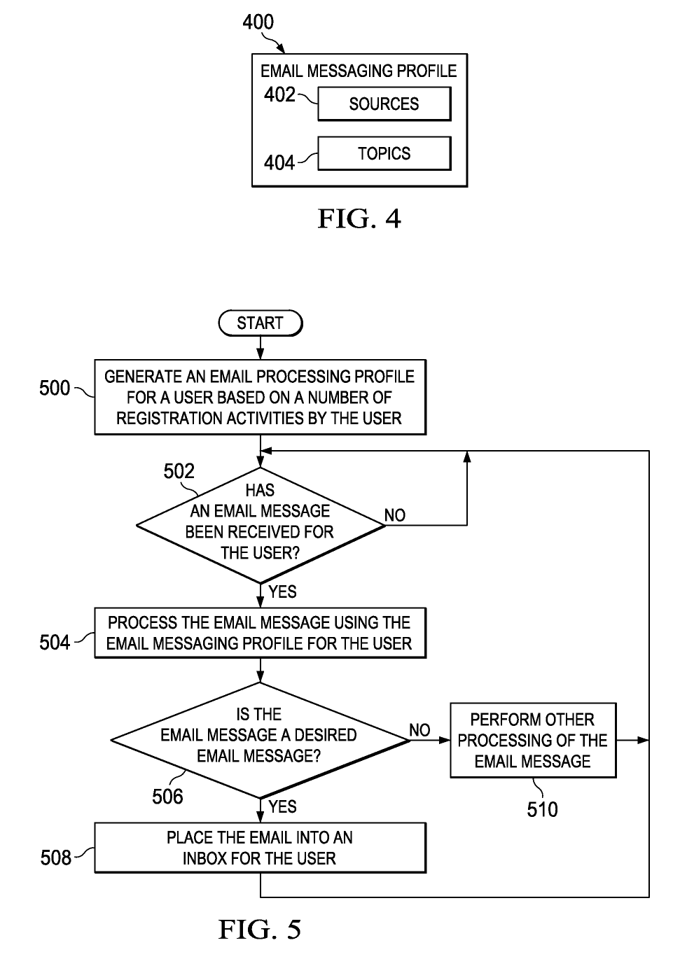

With reference now to FIG. 4, an illustration of an email processing profile is depicted in accordance with an illustrative embodiment. In this illustrative example, email messaging profile 400 comprises sources 402 and topics 404. Sources 402 may take a number of different forms. Sources 402 may be, for example, without limitation, at least one of an email address, a domain name, or some other suitable type of identifier. As used herein, the phrase “at least one of”, when used with a list of items, means that different combinations of one or more of the listed items may be used and only one of each item in the list may be needed. For example, “at least one of item A, item B, and item C” may include, without limitation, item A, or item A and item B. This example also may include item A, item B, and item C, or item B and item C.

For example, sources 402 may be domain names of websites with which a user has performed registration activities. For example, if a user supplies an email address to register at a website. The user may register for various promotions, coupons, email newsletters, and other suitable types of information. The domain name of the website where the user performs this registration activity is included as a source in sources 402.

In yet another illustrative example, the user may perform a registration activity by selecting an email address on a web page for the website. A user may send an email message to this email address. This email address may be placed into sources 402.

Additionally, if the user identifies various topics that the user is interested in at the website, those registration activities are included in topics 404. For example, a user may register at a website as being interested in women's clothing but not men's clothing. As a result, the identification of women's clothing is used in topics 404.

With email messaging profile 400, email messages for a user may be processed to identify email messages that the user desires to see. For example, if an email from a domain name listed in sources 402 is received, sources 402 are used to identify that email message as potentially being a desired email message. A policy for processing email messages may allow the email message to be placed into the inbox for the user. In some cases, the policy may include additional rules identifying topics in topics 404 for a particular domain. In this case, the email message is further examined to determine whether the email message contains topics of interest.

For example, if the email message in the “re:” line or the body includes the phrase “women's clothing”, then the email message is identified as one that the user desires to read. This email will then be placed into an inbox of the user. If the email message does not contain the phrase “women's clothing” but includes “men's clothing”, then the email message is not identified as one that is to be delivered to the user's inbox. This email message may be retained in another folder for undesired email messages.

As another illustrative example, the email message is identified as a desired email message when the email message matches a topic and is sent from a trusted source. In other words, if an email message matches a topic but is not sent from a trusted source, the email message is not placed into the inbox of the user. The determination of whether the email message is a desired message is based on the email processing profile generated based on registration activities conducted by the user.

These types of email messages may be considered trusted email messages that are delivered to the user's inbox. Additionally, sources 402 also may include specific email addresses. In one illustrative example, if the user goes to a website and uses the user's email address to register for products of interest, the user also may identify a corresponding website email address. As one illustrative example, the website can be searched to find an email address or a basic contact email address, such as contact@applications.com. Sources 402 would include any email address ending in “@applications.com”.

With reference now to FIG. 5, a flowchart of a process for processing email messages is depicted in accordance with an illustrative embodiment. The process illustrated in FIG. 5 may be implemented in program code for a process, such as message process 328 in FIG. 3.

The process begins by generating an email processing profile for a user based on a number of registration activities by the user (step 500). Thereafter, a determination is made as to whether an email message has been received for the user (step 502). If an email message has not been received for the user, the process returns to step 502. If an email message has been received for the user, the process processes the email message using the email messaging profile for the user (step 504). Thereafter, a determination is made as to whether the email message is a desired email message (step 506). This determination is made using, for example, any one of email processing profiles 332 in FIG. 3 and/or email messaging profile 400 in FIG. 4.

If the email message is a desired email message, the email is placed into an inbox for the user (step 508), with the process then returning to step 502. Otherwise, if the email message is not a desired email message, the process then performs other processing of the email message (step 510), with the process then returning to step 502. In step 510, the other processing may take a number of different forms. For example, additional processing of the email message may be made to determine whether the email message is an undesired email message. The process in step 506 determines whether the email message comes from a source on a white list. In other words, a white list is a list of sources for which email messages are always accepted.

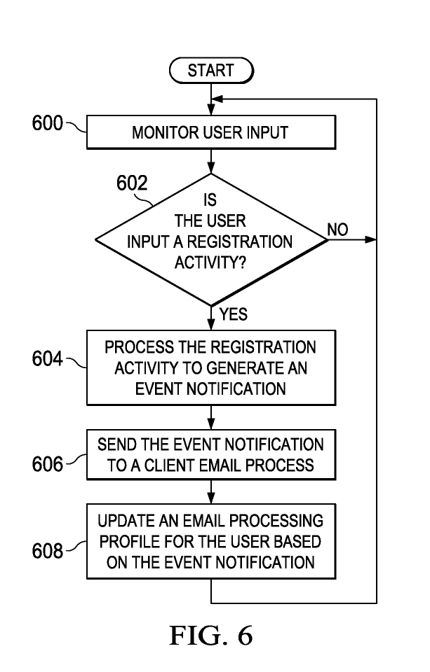

With reference now to FIG. 6, a flowchart of a process for generating a history of registration activities is depicted in accordance with an illustrative embodiment. The process illustrated in FIG. 6 may be implemented using email messaging system 300 in FIG. 3. Further, the process may be implemented using programs, such as, for example, email server process 304, browser application 340, and client email process 308 in FIG. 3.

The process begins by monitoring user input (step 600). In some illustrative examples, the process may begin monitoring user input in response to the user entering the user's email address on, for example, a website. The user enters the input through the browser application.

In these illustrative examples, these input fields may be located on a web page on which a user registers for more information and/or to process a purchase. The user input also may include other information about the user or user preferences on the web page. For example, the information about the user may include an alternate email address. The preferences may include topics or items that the user is interested in at the website. For example, the user may be interested in a storage device that is out of stock or not yet available. In this case, the user may register to obtain information about when the storage device will be available. This web page may then be submitted to generate the user input monitored for in step 600.

Thereafter, a determination is made as to whether the user input is a registration activity (step 602). For example, in step 602, the input may be considered a registration activity when the user logs onto a website, signs up for a service provided by the website, joins an emailing list, clicks on a button indicating interest in the website, enters information about the user into input fields on the website, and/or enters other suitable types of user input. Not all user input on the web site may be considered a registration activity.

In one illustrative example, step 602 may determine whether the user inputs an email address into an input field. For example, the process may monitor for the entering of information with an “@” symbol. Additionally, the process also may monitor for entry of the user's email address from a list of email addresses for the user.

If the input is a registration activity, the registration activity is processed to generate an event notification (step 604). In step 604, the domain of the website may be identified and generate an event notification. In other words, the event notification may include the domain name of the website. Additionally, in step 604, information about user preferences also may be identified from other user input to the web page at the website. This information also may be identified and placed into the event notification. This additional information may be used for identifying desired emails from the particular domain. The information may be used to omit messages that do not include the preferences input by the user.

Step 604 may be performed using email server process 304 running on server computer 306 in FIG. 3. The process then sends the event notification to a client email process (step 606). Next, the client email process updates an email processing profile for the user based on the event notification (step 608). Updating the email processing profile may include at least one of adding a set of rules to the email processing profile for filtering emails, changing a set of rules already present in the email processing profile, removing a set of rules present in the email processing profile, and/or performing other suitable update operations.

Thereafter, the process returns to step 600. With reference again to step 602, if the user input is not a registration activity, the process also returns to step 600. In some illustrative examples, the registration activity may be added to a history of registration activities in response to a determination that the user input is a registration activity.

In this illustrative example, the email processing profile is located on the client computer on which the client email process runs. However, in other illustrative examples, the email processing profile may be located on the server computer on which the email server process runs.

As an example, the user may go to the MyStore website. The user may select a registration link and fill in information on the web page that is returned for the registration link. In this example, the user input may be the email address for the user and a preference for information about topics X and Y. This user input is an example of user input that may be monitored for in step 600 in FIG. 6.

This type of user input is identified in step 602 as a registration activity. As a result, an identification of the domain address for the MyStore website may be made in step 604. In this example, the domain address may be “@MyStore.com” with this information being included in an event. Additionally, the topics X and Y entered by the user on the web page in registering with the website also may be identified as user preferences and placed into the event in step 604. This event information may then be sent and used to update a profile for the user in steps 606 and 608.

As a result, an email that comes from @MyStore.com with a subject, including topic X, is identified as a desired email message that is delivered to the user's inbox in steps 506 and 508 in FIG. 5. An email from @MyStore.com with a subject topic Z is not identified as a desired message and is not automatically sent to the inbox of the user in steps 506 and 510 in FIG. 5.

Thus, the different illustrative embodiments provide a method and apparatus for processing email messages. In the different illustrative embodiments, an email processing profile is generated for a user based on a number of registration activities by the user. When an email message is received for the user, the email message is processed using the email processing profile.

The different illustrative embodiments provide a capability to identify desired email messages that should be sent to an inbox of a user. The identification of desired email messages may be performed using the different illustrative embodiments more easily than with current techniques. The different illustrative embodiments use registration activities to identify sources from which email messages may be desired.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be processed substantially concurrently, or the blocks may sometimes be processed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

For example, in some illustrative examples, rather than sending a registration activity each time, the process may wait for a period of time or for some number of registration activities to be identified before sending the registration activities to a history of registration activities for the user.

The terminology used herein is for the purpose of describing particular embodiments only and is not intended to be limiting of the invention. As used herein, the singular forms “a,” “an,” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means, or step plus function elements in the claims below, are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for processing email messages, the method comprising:
generating, by a processor unit, an email processing profile for a user based on a number of registration activities by the user; and
responsive to receiving an email message for the user, processing, by the processor unit, the email message using the email processing profile.

2. The method of claim 1, wherein a registration activity in the number of registration activities comprises inputting an email address for the user into a web page form.

3. The method of claim 1, wherein a profile comprises a rule allowing the email messages to reach an inbox for the user from a web domain for which the user has conducted a registration activity.

4. The method of claim 1 further comprising:
monitoring user input entered by the user into a browser application; and
responsive to detecting a registration activity by the user, updating the email processing profile for the user.

5. The method of claim 4, wherein the step of updating the email processing profile for the user in response to detecting the registration activity by the user comprises at least one of adding a rule to the email processing profile, changing the rule in the email processing profile, and removing the rule from the email processing profile.

6. The method of claim 1, wherein the step of responsive to receiving the email message for the user, processing, by the processor unit, the email message using the email processing profile comprises:
determining whether the email message is a desired email message using the email processing profile; and
responsive to a determination that the email message is the desired email message, placing the email message in an inbox for the user.

7. The method of claim 1, wherein the email processing profile comprises at least one of an identification of a sender and a topic.

8. The method of claim 4 further comprising:
responsive to detecting the registration activity by the user, adding the registration activity to a history of registration activities.

9. The method of claim 8, wherein the monitoring step and the adding step are performed by a plug-in for the browser application.

10. A data processing system comprising:
a bus;
a storage device connected to the bus, wherein the storage device contains computer readable code; and
a processor unit connected to the bus, wherein the processor unit is configured to run the computer readable code to generate an email processing profile for a user based on a number of registration activities by the user and process an email message using the email processing profile in response to receiving the email message for the user.

11. The data processing system of claim 10, wherein a registration activity in the number of registration activities comprises inputting an email address for the user into a web page form.

12. The data processing system of claim 10, wherein the email processing profile comprises a rule allowing email messages to reach an inbox for the user from a web domain for which the user has conducted a registration activity.

13. The data processing system of claim 10, wherein the processor unit is further configured to monitor user input entered by the user into a browser application; and
update the email processing profile for the user in response to detecting a registration activity by the user.

14. The data processing system of claim 13, wherein in being configured to update the email processing profile for the user in response to detecting the registration activity by the user, the processor unit is configured to perform at least one of adding a rule to the email processing profile, changing the rule in the email processing profile, and removing the rule from the email processing profile.

15. The data processing system of claim 10, wherein in being configured to run the computer readable code to process, the processor unit is configured to run the computer readable code to determine whether the email message is a desired email message using the email processing profile and place the email message in an inbox for the user in response to a determination that the email message is the desired email message, wherein the email processing profile comprises at least one of an identification of a sender and a topic.

16. A computer program product for processing email messages comprising:
a computer readable storage medium having computer readable program code stored thereon, the computer readable program code for processing by a computer, comprising:
computer readable program code for generating an email processing profile for a user based on a number of registration activities by the user; and
computer readable program code, responsive to receiving an email message for the user, for processing the email message using the email processing profile.

17. The computer program product of claim 16, wherein a registration activity in the number of registration activities comprises inputting an email address for the user into a web page form.

18. The computer program product of claim 16, wherein the computer readable program code, responsive to receiving the email message for the user, processing, by the processor unit, the email message using the email processing profile comprises:
computer readable program code for determining whether the email message is a desired email message using the email processing profile; and
computer readable program code, responsive to a determination that the email message is the desired email message, for placing the email message in an inbox for the user.

19. The computer program product of claim 16, wherein the computer readable program code is stored in the computer readable storage medium in a data processing system and wherein the computer readable program code is downloaded over a network from a remote data processing system to the computer readable storage medium in the data processing system.

20. The computer program product of claim 16, wherein the computer readable storage medium is stored in a first computer readable storage medium in a server data processing system, and wherein the computer readable program code is downloaded over a network to a remote data processing system for use in a second computer readable storage medium in the remote data processing system.
